(19) United States
(12) Patent Application Publication
(10) Pub. No.: US 2007/0191213 A1
(43) Pub. Date: Aug. 16, 2007

(54) Metal-containing compositions and their use as catalyst composition

(75) Inventors: William Jones, Cambridge (GB); Paul O'Connor, Km Hoevelaken (NL); Dennis Stamires, Newport Beach, CA (US)

Correspondence Address: Albemarle Netherlands B.V.;Patent and Trademark Department, 451 Florida Street, Baton Rouge, LA, 70801, US

(73) Assignee: ALBEMARLE NETHERLANDS B.V., Amersfoort (NL)

(21) Appl. No.: 10/557,921

(22) PCT Filed: May 19, 2004
(86) PCT No.: PCT/EP04/05562

§ 371 Date: Mar. 19, 2007

Related U.S. Application Data
(60) Provisional application No. 60/472,653, filed on May 22, 2003.

(30) Foreign Application Priority Data
Jun. 24, 2003 (EP) 03076950.9

(51) Int. Cl. B01J 38/00; B01J 29/06

(52) U.S. Cl. 502/20; 502/202; 502/207; 502/305; 502/306; 502/307; 502/314; 502/315; 502/318; 502/335; 502/338; 502/340; 502/341; 502/345; 502/346; 502/353; 502/355; 502/64; 502/66; 502/74; 502/84

(57) ABSTRACT

Metal-containing composition and use thereof in catalytic reactions, which metal-containing composition is obtainable by contacting a metal hydroxy salt with a solution comprising one or more pH-dependent anions selected from the group consisting of pH-dependent boron-containing anions, vanadium-containing anions, tungsten-containing anions, molybdenum-containing anions, iron-containing anions, niobium-containing anions, tantalum-containing anions, aluminium-containing anions, and gallium-containing anions.

The present invention relates to a metal-containing composition obtainable by contacting a metal hydroxy salt with a solution comprising one or more anions.

Metal hydroxy salts (MHS) are compounds comprising (i) as metal either one or more divalent or one or more trivalent metal(s), (ii) framework hydroxide, and (iii) one or more replaceable anions.

The term “framework hydroxide” means: non-replaceable hydroxide bonded to the metal(s). Additionally, metal hydroxy salts contain replaceable anions. The term “replaceable anion” means: anions which have the ability, upon contacting the MHS with a solution of other anions under suitable conditions, to be replaced (e.g. ion-exchanged) with these other anions.

An example of an MHS is a hydroxy salt of a divalent metal according to the following idealised formula: [(Me²⁺,M²⁺)₂(OH)₃]⁺(Xⁿ⁻)_{1/n}], wherein Me²⁺ and M²⁺ represent the same or different divalent metal ions, OH refers to the framework hydroxide, X is the replaceable anion, and n is the valency of X. Another example of MHS has the general formula [(Me²⁺,M²⁺)₅(OH)₈]²⁺(Xⁿ⁻)_{2/n}], wherein Me²⁺ and M²⁺ can be the same or different divalent metal ions, OH refers to the framework hydroxide, X is the replaceable anion, and n is the valancy of X.

Examples of [(Me²⁺,M²⁺)₂(OH)₃(Xⁿ⁻)_{1/n}]-type MHS are Cu₂(OH)₃NO₃ and CuₓCo₂₋ₓ(OH)₃NO₃. If the MHS contains two different metals, the ratio of the relative amounts of the two metals may be close to 1. Alternatively, this ratio may deviate substantially from 1, meaning that one of the metals predominates over the other. It is important to appreciate that these formulae are ideal and that in practice the overall structure will be maintained although chemical analysis may indicate compositions not satisfying the ideal formula. For example, in layered structures such as ZnCo_{0.39}(NO₃)_{0.44}(OH)_{2.33} and ZnCu_{1.5}(NO₃)_{1.33}(OH)_{3.88} ideally approximately 25% of the framework hydroxides is replaced by NO₃⁻ ions. In these structures, one oxygen of the NO₃⁻ ion occupies the position of one framework hydroxide whereas the other two oxygen ions lie between the layers. One may therefore describe the layers with the formula [(Me²⁺,M²⁺)₂(OH)₃O]⁺.

An example of [(Me²⁺,M²⁺)₅(OH)₈]²⁺(Xⁿ⁻)_{2/n}]-type MHS is [(Zn)₅(OH)₈(NO₃)₂)]. The structure of this material consists of brucite-type [Zn₃(OH)₈]²⁻ layers with 25% of the octahedral positions remaining unoccupied. Above and below these vacant octahedral sites are located tetrahedrally coordinated Zn ions, one on each side of the layer. Such a two-fold replacement of the octahedral Zn ion gives rise to a charge on the layers and the need for charge balancing and replaceable anions within the interlayer. Examples of mixed metal systems based on this structure that have been reported include Zn_{3.2}Ni_{1.8}(OH)₈(NO₃)_{1.7}(OH)_{0.3} and Zn_{3.6}Ni_{1.4}(OH)₈(NO₃)_{1.6}(OH)_{0.4}. These two formulae indicate that two (and indeed more) different metals may be present in the layer and that anion exchange may also occur (i.e. OH⁻ replacing NO₃⁻). Yet another example of MHS is illustrated by [M³⁺(OH)₂]⁺(Xⁿ⁻)_{1/n}, such as La(OH)₂NO₃, in which the metal is now trivalent. In this material the nitrate anion is considered to be present within the interlayer region and not directly bonded to the layers. The ability to introduce La into a composition in this pure state is particularly advantageous for catalyst manufacturers, as will be obvious to those experienced in the art of catalyst manufacture.

As explained above, some of the divalent metal based MHS-structures described above may be considered as an alternating sequence of modified brucite-like layers in which the divalent metal(s) is/are coordinated octrahedrally with the framework hydroxide ions. In one family, the framework hydroxide is partially replaced by other anions (e.g. nitrate). In another family, vacancies in the octahedral layers are accompanied by tetrahedrically coordinated cations. Another structure of metal hydroxides is the three-dimensional structure depicted in Helv. Chim Acta 47 (1964) 272-289.

The term “metal hydroxy salt” includes the materials referred to in the prior art as “(layered) hydroxy salt”, “(layered) hydroxy double salt”, and “layered basic salt”. For work on these types of materials reference is made to:
J. Solid State Chem. 148 (1999) 26-40
Recent Res. Devel. In Mat Sci. 1 (1998) 137-188
Solid State Ionics 53-56 (1992) 527-533
Inorg. Chem. 32 (1993) 1209-1215
J Mater. Chem. 1 (1991) 531-537
Russian J Inorganic Chemistry, 30, (1985) 1718-1720
Reactivity of Solids, 1, (1986) 319-327
Reactivity of Solids, 3, (1987) 67-74
Compt. Rend. 248, (1959) 3170-3172
C. S. Bruschini and M. J. Hudson in Progress in Ion Exchange; Advances and Applications (Eds. A. Dyer, M. J. Hudson, P. A. Williams), Cambridge, Royal Society of Chemistry, 1997, pp. 403-411.

The invention relates to a new metal-containing composition obtainable by contacting a metal hydoxy salt with a solution comprising one or more pH-dependent anions selected from the group consisting of pH-dependent boron-containing anions, pH-dependent vanadium-containing anions, pH-dependent tungsten-containing anions, pH-dependent molybdenum-containing anions, pH-dependent iron-containing anions, pH-dependent niobium-containing anions, pH-dependent tantalum-containing anions, pH-dependent aluminium-containing anions, and pH-dependent gallium-containing anions.

These pH-dependent anions provide new metal functions which can make the resulting metal-containing compositions very suitable for specific applications, e.g. specific catalytic applications. For example, if the anions of a Ni—Co MHS (e.g. OH⁻ or NO₃⁻) are exchanged with MoO₇⁶⁻, a composition is obtained which contains Mo centres in addition to Ni and Co centres. Depending on the anion and the conditions used, the resulting metal-containing composition will be an MHS with MoO₇⁶⁻ anions between its layers, a composition comprising Ni, Co, and Mo-containing layers, or a combination thereof. Such metal-containing compositions can very suitably be used as a catalyst in hydroprocessing reactions, in particular after calcining and sulphiding.

pH-Dependent Anions

pH-dependent anions are anions which, when dissolved in water, can change in structure and composition upon the pH of the solution being changed.

The pH-dependent anion(s) is/are selected from the group consisting of pH-dependent boron-containing anions, vanadium-containing anions, tungsten-containing anions, molybdenum-containing anions, iron-containing anions, niobium-containing anions, tantalum-containing anions, aluminium-containing anions, and gallium-containing anions.

Examples of pH-dependent boron-containing anions are borates such as BO₃²⁻, B(OH)₄⁻, [B₂O(OH)₅]⁻, [B₃O₃(OH)₄]⁻, [B₃O₃(OH)₅]²^{^{−}}, and [B₄O₅(OH)₄]²^{^{−}}.

Examples of pH-dependent vanadium-containing anions are vanadates such as VO₃⁻, VO₄³⁻, HVO₄²⁻, H₂VO₄⁻, V₂O₇⁴⁻, HV₂O₇³⁻, V₃O₉³⁻, V₄O₁₂⁴⁻, V₁₀O₂₈⁶⁻, HV₁₀O₂₈⁵⁻, H₂V₁₀O₂₈⁴⁻ V₁₈O₄₂¹²⁻, and V-containing heteropolyacids such as V₃W₃O₁₉⁵⁻ and VW₅O₁₉⁴⁻.

Examples of pH-dependent tungsten-containing anions are tungstates such as WO₄²⁻, HW₆O₂₁⁵⁻, W₇O₂₄⁶⁻, W₁₀O₃₃⁴⁻, W₁₂O₄₀⁴⁻, W₁₈O₆₂⁶⁻, W₂₁O₈₆⁸⁻, and W-containing heteropolyacids such as V₃W₃O₁₉⁵⁻, VW₅O₁₉⁴⁻, [SiW₁₁Fe(OH)O₃₉]⁶⁻, NbW₅O₁₉³⁻, and Nb₄W₂O₁₉⁶⁻,

Examples of pH-dependent molybdenum-containing anions are molybdates such as MoO₄⁻, Mo₆O₁₉²⁻, Mo₇O₂₄⁶⁻, and Mo₈O₂₄⁴⁻

Examples of pH-dependent iron-containing anions are Fe(OH)₄⁻, Fe(OH)₆⁴⁻, Fe(OH)₆³⁻, and [SiW₁₁Fe(OH)O₃₉]⁶⁻,

Examples of pH-dependent niobium-containing anions are niobates such as NbO₄³⁻, Nb₄O₁₆¹²⁻, Nb₆O₁₉⁸⁻, HNb₆O₁₉⁸⁻, H₂Nb₆O₁₉⁶⁻, Nb₁₀O₂₈⁶⁻, [NbO₂(OH)₄]³⁻, and Nb-containing heteropolyacids such as NbW₅O₁₉³⁻ and Nb₄W₂O₁₉⁶⁻.

Examples of pH-dependent tantalum-containing anions are tantalates such as TaO₄³⁻, Ta₆O₁₉⁸⁻, and HTa₆O₁₉⁷⁻.

Examples of pH-dependent aluminium-containing anions are AlW₁₁O₃₉ⁿ⁻ and AlV^{IV}₂V^{V}₁₂O₄₀⁹⁻.

For more information and examples of pH-dependent anions reference is made to M. T. Pope, Heteropoly and Isopoly Oxometalates, Spinger-Verlag Berlin, Heidelberg 1983.

The table below lists several anion forms with their corresponding pH range.

TABLE

| Anion | pH range |
|---|---|
| B(OH)₄⁻ | >10.5 |
| [B₃O₃(OH)₄]⁻ | 7.5-9.5 |
| [B₃O₃(OH)₅]²⁻ | 8.5-10 |
| [B₄O₅(OH)₄]²⁻ | 8.5-9.5 |
| V₂O₇⁴⁻ | 10-13 |
| HV₂O₇³⁻ | 8-10 |
| V₃O₉³⁻ | 6.5-8 |
| V₄O₁₂⁴⁻ | 6.5-8 |
| V₁₀O₂₈⁶⁻ | 6-7 |
| V₃W₃O₁₉⁵⁻ | 2-3 |
| VW₅O₁₉⁴⁻ | 3-5 |
| NbW₅O₁₉³⁻ | 1.5-5 |
| Nb₄W₂O₁₉⁶⁻ | >8.5 |

In addition to the pH-dependent anion(s), the metal-containing composition according to the invention may contain other organic or inorganic anions. These include inorganic anions such as NO₃⁻, NO₂⁻, CO₃²⁻, HCO₃⁻, SO₄²⁻, SO₃NH₂⁻, SCN⁻, S₂O₆²⁻, SeO₄⁻, F⁻, Cl⁻, Br⁻, I⁻, ClO₃⁻, ClO₄⁻, BrO₃⁻, and IO₃⁻, silicate, aluminate and metasilicate, and organic anions such as acetate, oxalate, and formate, long chain carboxylates (e.g. sebacate, caprate and caprylate (CPL)), alkyl sulphates (e.g. dodecyl sulphate (DS) and dodecylbenzene sulphate), stearate, benzoate, phthalocyanine tetrasulphonate, and polymeric anions such as polystyrene sulphonate, polyvinyl benzoates, and poly(meth)crylates.

The advantage of the presence of these organic anions is that upon heating of the metal-containing composition these anions are decomposed, thereby creating porosity. Furthermore, these organic anions may introduce hydrophilic and/or hydrophobic characteristics into the metal-containing composition, which can be advantageous for catalytic purposes, e.g. when individual catalyst components are brought together to form a single catalyst particle. The organic anions are also useful for pillaring, delamination, and exfoliation of the metal-containing composition, which may lead to the formation of nanocomposites comprising the metal-containing composition, optionally in a matrix of organic polymer, resins, plastics, rubbers, pigments, paints, dyes, coatings.

Metal Hydroxy Salts

Suitable divalent metals in MHS-structures include Ni²⁺, Co²⁺, Cu²⁺, Cd²⁺, Ca²⁺, Zn²⁺, Mg²⁺, Fe²⁺, and Mn²⁺.

Examples of suitable metal hydroxy salts that comprise only one type of metal are Zn-MHS (e.g. Zn₅(OH)₈(X)₂, Zn₄(OH)₆X), Cu-MHS (e.g. Cu₂(OH)₃X, Cu₄(OH)₆X, Cu₇(OH)12(X)₂), Co-MHS (e.g. Co₂(OH)₃X, Ni-MHS (e.g. Ni₂(OH)₃X), Mg-MHS (e.g. Mg₂(OH)₃X), Fe-MHS, Mn-MHS, and La-MHS (La(OH)₂NO₃).

Examples of suitable metal hydroxy salts comprising two or more different types of metals are Zn—Cu MHS, Zn—Ni MHS, Zn—Co MHS, Fe—Co MHS, Zn—Mn MHS, Zn—Fe MHS, Ni—Cu MHS, Cu—Co MHS, Cu—Mg MHS, Cu—Mn MHS, Ni—Co MHS, Zn—Fe—Co MHS, Mg—Fe—Co MHS, and Ni—Cu—Co MHS, Mg—Ni MHS, Mg—Mn MHS, Mg—Fe MHS, Cu—Fe MHS, Mg—Cu—Fe MHS, Mg—Zn—Fe MHS, Ni—Co—Mg MHS.

Preparation of Metal Hydroxy Salts

Metal hydroxy salts can be prepared by several methods. Method 1 involves the reaction of a metal oxide or hydroxide with a dissolved metal salt, e.g. a nitrate, in a slurry. Method 2 involves (co-)precipitation from metal salt solutions.

For method 1 reference is made Inorg. Chem. 32 (1993) 1209-1215; for method 2 reference is made to J. Solid State Chem. 148 (1999) 26-40 and J. Mater. Chem. 1 (1991) 531-537. These references all relate to the preparation of hydroxy (double) salts, which materials are covered by the term “metal hydroxy salt”.

If the MHS is formed from or in the presence of solid compound(s), it may be desirable to mill (one of) these compound(s). In this specification the term “milling” is defined as any method that results in reduction of the particle size. Such a particle size reduction can at the same time result in the formation of reactive surfaces and/or heating of the particles. Instruments that can be used for milling include ball mills, high-shear mixers, colloid mixers, and electrical transducers that can introduce ultrasound waves into a slurry. Low-shear mixing, i.e. stirring that is performed essentially to keep the ingredients in suspension, is not regarded as milling.

Additives can be added at any process stage. For instance, in method 1, a salt or (hydr)oxide of the desired additive can be present during the reaction to form an MHS. Furthermore, a metal (hydr)oxide which already contains the additive can be used.

In method 2, a metal salt of the desired additive can be co-precipitated with the divalent metal(s) which form(s) the MHS. Additionally, additives can be precipitated or impregnated on the formed MHS.

Method 1 is preferably conducted in a continuous fashion. More preferably, it is conducted in an apparatus comprising two or more conversion vessels, such as the apparatus described in the United States patent application published under no. US 2003-0003035 A1.

For example, a slurry containing the metal salt and the metal oxide is prepared in a feed preparation vessel, after which the mixture is continuously pumped through two or more conversion vessels. Additives, acids, or bases, if so desired, may be added to the mixture in any of the conversion vessels. Each of the vessels can be adjusted to its own desirable temperature.

Preparation of the Metal-Containing Composition According to the Invention

The metal-containing composition according to the invention can be prepared by contacting one or more metal hydroxy salts with a solution containing one or more pH-dependent anions.

In order to obtain a solution containing the desired pH-dependent anion, the pH of the solution is adjusted with acid or base to shift the pH-dependent equilibrium in the desired direction. If an acid is required for pH adjustment, a mineral acid such as nitric or hydrochloric acid can be used, or an organic acid such as acetic, formic, propionic, or oxalic acid. If a base is required, it preferably is ammonium hydroxide, ammonium carbonate, or a tetra-alkyl ammonium hydroxide. These bases are preferred, because they do not contain alkali metal and therefore enable the preparation of an alkali-free metal-containing composition according to the invention without requiring washing or filtering steps. This is particularly advantageous for metal-containing compositions according to the invention used for catalytic applications, because for most catalytic applications (e.g. FCC) the presence of alkali metals—especially sodium—is undesirable.

The stability of the metal hydroxy salt(s) can also be pH-dependent. Some metal hydroxy salts are not very stable under acidic conditions, while others are not very stable under basic conditions. Hence, in choosing the pH of the solution, one also has to take the stability of the MHS into account.

However, using a pH under which the metal hydroxy salt(s) is/are not very stable is not necessarily undesirable: if parts of the MHS layers dissolve, the dissolved metals may eventually be deposited on the metal-containing composition (e.g. by a subsequent precipitation, or during drying), giving an extra functionality. For instance, contacting a Zn-MHS with a vanadate anion under conditions which dissolve part of the MHS layers may result in the deposition of a zinc vanadate salt on the MHS during drying. The resulting metal-containing composition—optionally after addition to other components such as alumina, titania, silica-alumina, zeolites, or clays—may suitably be used in FCC for the preparation of fuels with a reduced sulphur content.

The contact between the metal hydroxy salt(s) and the pH-dependent anion preferably lasts for at least 1 minute to 24 hours, more preferably 5 minutes to 12 hours, and most preferably 15 minutes to 4 hours.

The pH of the solution may change as the reaction proceeds, so that the anion in the solution may change in structure. This may be useful for different anions to be incorporated. However, it might be appropriate to maintain the pH at a constant level during the reaction by adding suitable acids and bases.

The temperature during this contact generally is between 25 and 300° C. A preferred temperature range below 100° C. is 50-70° C.; a preferred temperature range above 100° C. is 120-160° C. This contact may be performed in air or in a carbon dioxide-free atmosphere.

After contacting the MHS with the pH-dependent anion, the resulting metal-containing composition may be isolated, optionally washed and filtered, and dried.

The metal-containing composition can be shaped to form shaped bodies. Suitable shaping methods include spray-drying, pelletising, extrusion (optionally combined with kneading), beading, or any other conventional shaping method used in the catalyst and absorbent fields or combinations thereof. Preferably, he metal-containing composition is shaped in the form of particles with a diameter of less than 500 nm.

The (shaped) metal-containing composition according to the invention can then be calcined, reduced, steamed, rehydrated, ion-exchanged and/or sulphided. Calcination is carried out by heating the metal-containing composition in oxidising or inert atmosphere at a temperature between 200 and 1,000° C., preferably 200-800° C.

Sulphidation can be carried out by any method known in the prior art. Generally, it involves contacting the metal-containing composition with a sulphur-containing compound such as elementary sulphur, hydrogen sulphide, DMDS, or polysulphides. Sulphidation can generally be carried out in situ and/or ex situ. Reduction is performed by heating in hydrogen atmosphere at a preferred temperature of 100-800° C., preferably 200-500° C.

The calcined (shaped) metal-containing composition may then be treated in a solution containing metal salts. Suitable metal salts include salts of transition metals (e.g. V, Mo, W, Cr, Mn, Ni, Co, Fe), noble metals (e.g. Pt, Pd), and rare earth metals (e.g. Ce, La) with anions. Suitable anions for these metals include inorganic anions such as NO₃⁻, NO₂⁻, CO₃²⁻, HCO₃⁻, SO₄²⁻, SO₃NH₂⁻, SCN⁻, S₂O₆²⁻, SeO₄⁻, F⁻, Cl⁻, Br⁻, I⁻, ClO₃⁻, ClO₄⁻, BrO₃⁻, and IO₃⁻, silicate, aluminate and metasilicate, and organic anions such as acetate, oxalate, formate, long chain carboxylates (e.g. sebacate, caprate and caprylate (CPL)), alkyl sulphates (e.g. dodecyl sulphate (DS) and dodecylbenzene sulphate), stearate, benzoate, phthalocyanine tetrasulphonate, and polymeric anions such as polystyrene sulphonate, polyimides, vinyl benzoates, and vinyl diacrylates, as well as pH-dependent boron-containing anions, bismuth-containing anions, thallium-containing anions, phosphorus-containing anions, silicon-containing anions, chromium-containing anions, vanadium-containing anions, tungsten-containing anions, molybdenum-containing anions, iron-containing anions, niobium-containing anions, tantalum-containing anions, manganese-containing anions, aluminium-containing anions, and gallium-containing anions.

The metal-containing composition according to the invention, optionally after a calcination, reduction and/or sulphidation step, may be composed with other compounds to form a catalyst or sorbent composition. This other compound is solid at room temperature and selected from the group consisting of metal (hydr)oxides, clays (including modified clays such as acid-activated clays and phosphated clays), (modified or doped) aluminium phosphates, zeolites, phosphates (e.g. meta or pyro phosphates), pore regulating agents (e.g. sugars, surfactants, polymers), binders, fillers, and combinations thereof. Suitable metal bearing sources include compounds of transition metals (e.g. V, Mo, W, Cr, Mn, Ni, Co, Fe), noble metals (e.g. Pt, Pd), and rare earth metals (e.g. Ce, La).

Examples of metal oxides, hydroxides, binders, and fillers are alumina (e.g. boehmite, gibbsite, flash-calcined gibbsite, gel alumina, amorphous alumina), silica, silica-alumina, titania, titania-alumina, zirconia, boria, (modified) mesoporous oxides (e.g. MCM-type zeolites, and mesoporous aluminas), and phosphates.

Suitable zeolites include pentasil zeolites (e.g. ZSM-5, zeolite beta, silicalite) and faujasite zeolites (e.g. zeolite X or Y, REY, USY, RE-USY). Suitable clays include anionic clays (i.e. layered double hydroxides or hydrotalcite-like materials), cationic clays (e.g. smectites, laponite, bentonite, hectorite, and saponite), (meta)kaolin, dealuminated kaolin, and desilicated kaolin.

Such catalyst or sorbent compositions can be prepared by mixing the other compound(s) or precursor(s) thereof with the metal-containing composition according to the invention, i.e. after contacting the MHS with the pH-dependent anion. Alternatively, they can be admixed with the MHS before such contacting. In the first case, it is preferred to add the metal-containing composition according to the invention to a slurry having a pH in the range 2-10 and comprising the other compound(s) or precursor(s) thereof and (ii) spray-drying the slurry.

In the second case, the metal hydroxy salt may be prepared in the presence of the other compound(s) or precursor(s) thereof, or the other compound is formed during the preparation of the MHS according to method 1 (see above) by using an excess of divalent metal (hydr)oxide. The resulting composition of MHS and other compound(s) is then contacted with the pH-dependent anion in order to form a metal-containing composition according to the invention. So, for example, it is possible to prepare an MHS in the presence of (flash-calcined) aluminium trihydrate. This will result in a composition comprising MHS and (flash-calcined) aluminium trihydrate as the other compound. The (flash-calcined) aluminium trihydrate may be converted to boehmite by aging, resulting in a composition comprising MHS and boehmite as the other compound. The resulting MHS-containing composition is then contacted with the pH-dependent anion.

It is also possible to mix the other compound(s) with the metal-containing composition according to the invention after its calcination, reduction and/or sulphidation.

Use of the Composition

The metal-containing composition according to the invention can be used for the preparation of catalysts or additives for the reduction of SOₓ and/or NOₓ emissions from FCC regenerators, the removal of noxious gases (e.g. HCN, ammonia, or halogens such as Cl₂ and HCl) from steel mills, power plants, and cement plants, the reduction of the sulphur and/or nitrogen content in fuels such as gasoline and diesel, the conversion of CO to CO₂, and Fischer-Tropsch synthesis, hydroprocessing (hydrodesulphurisation, hydrodenitrogenation, demetallisation), hydrocracking, hydrogenation, dehydrogenation, alkylation, isomerisation, Friedel Crafts processes, ammonia synthesis, etc.

Furthermore, the metal-containing composition can be treated with organic agents, making the surface of the composition, which is generally hydrophilic in nature, more hydrophobic. This allows the composition to disperse more easily in organic media.

When applied as nanocomposites (i.e. particles with a diameter of less than about 500 nm), the metal-containing composition according to the invention can suitably be used in plastics, resins, rubber, and polymers. Nanocomposites with a hydrophobic surface, for instance obtained by treatment with an organic agent, are especially suited for this purpose.

The metal-containing composition may also be pillared, delaminated and/or exfoliated using known procedures.

Fischer Tropsch

For the preparation of a Fischer-Tropsch catalyst, metal-containing compositions according to the invention prepared from Fe and/or Co-containing MHS are very suitable. Suitable metal-containing compositions are prepared from, for example, Fe-MHS, Fe—Co MHS, Co-LDS, Fe—Zn MHS, Mg—Zn MHS Co—Fe MHS, Ni—Co-MHS and/or Zn—Co—Fe-MHS. Suitable pH-dependent anions are Fe-containing pH-dependent anions such as [SiW₁₁Fe(OH)O₃₉]⁶⁻, Fe(OH)₄⁻, Fe(OH)₆⁴⁻, and Fe(OH)₆³⁻.

Preferably, the Fischer-Tropsch catalyst additionally comprises alumina (e.g. pseudoboehmite), iron, zinc, cobalt and/or ruthenium-containing compounds. The Fischer-Tropsch catalyst is preferably reduced in a hydrogen atmosphere.

HPC

Examples of metal-containing compositions according to the invention suitable for the preparation of hydroprocessing (HPC) catalysts are metal-containing compositions prepared from Ni-MHS or Co—Ni MHS. Suitable pH-dependent anions are molybdates—such as MoO₄⁻, Mo₆O₁₉²⁻, Mo₇O₂₄⁶⁻, and Mo₈O₂₄⁴⁻— and tungstates—such as WO₄²⁻, HW₆O₂₁⁵⁻, W₇O₂₄⁶⁻, W₁₀O₃₃⁴⁻, W₁₂O₄₀⁴⁻, W₁₈O₆₂⁶⁻, and W₂₁O₈₆⁸⁻.

Suitable other compounds present in hydroprocessing catalysts include carrier materials such as alumina, silica, silica-alumina, magnesia, zirconia, boria, titania, or mixtures thereof, and metal salts.

Before use in HPC, the catalyst is sulphided, preferably after a calcination and/or reduction step.

FCC

The metal-containing composition according to the invention can be used for the preparation of FCC additives and FCC catalysts. FCC additives are materials which are used in conjunction with the FCC catalyst, i.e. in a two-particle system.

For this purpose, metal-containing compositions according to the invention prepared from Mg-MHS, Zn-MHS, Fe-MHS, Mg—Fe MHS, Zn—Fe MHS, and/or Zn—Cu MHS are preferred, with Zn-containing metal hydroxy salts being the most preferred. Preferred pH-dependent anions are vanadium-, tungsten-, niobium-, boron-, and molybdenum-containing anions.

More preferably, such metal-containing compositions also comprise a metal selected from the group of cerium, lanthanum, platinum, and palladium.

Apart from the metal-containing composition, FCC catalysts preferably comprise solid acid, binder and matrix materials (e.g, alumina, kaolin), diluents, extenders and/or anionic clays. Suitable solid acids are zeolites, such as zeolites based on faujasite-type zeolites (e.g. rare earth, transition metal and/or ammonium-exchanged zeolite X, zeolite Y, zeolite USY), and de-aluminated zeolites, mordenite, or small pore zeolites (e.g. ZSM-5, ZSM-21, zeolite-beta, as well as their metal-doped and phosphated forms) or modified forms thereof, silicoalumina phosphates (SAPOs), aluminium phosphates (AlPOs) and/or (modified forms of) mesoporous materials such as MCM-41 or mesoporous alumina.

FCC additives preferably comprise—apart from the metal-containing composition—small pore zeolite and matrix material (e.g. alumina). The metal-containing compositions are specifically suitable for the preparation of catalyst additives for the production of fuels with low sulphur content.

Use as Sorbent

The metal-containing composition according to the invention can suitably be used for the preparation of sorbents for, e.g., halogens (Cl₂, HCl), HCN, NH₃, SOx and/or NOx from flue gases of for instance power plants and FCC regenerators and for sulphur and/or nitrogen reduction in gasoline and diesel fuels. Such sorbents preferably also contain alumina, phosphates, titania, zirconia and/or silica-alumina.

Examples of suitable metal-hydroxy salts for this purposes are Mg-MHS, Zn-MHS, Fe-MHS, Mg—Fe MHS, Zn—Fe MHS, and Zn—Cu MHS. Preferred pH-dependent anions are vanadium-, tungsten-, molybdenum-, boron-, and niobium-containing anions.

More preferably, such sorbents also comprise a metal selected from the group of cerium, lanthanum, platinum, and palladium.

### DESCRIPTION OF THE FIGURES

FIG. 1 displays the sulphur taken up by the metal-containing compositions of Examples 3-8 when used as an additive in a microactivity test, compared with the sulphur taken up by E-cat in the absence of such compositions (“no additive”).

FIG. 2 displays the sulphur content of gasoline produced during a microactivity test using the metal-containing compositions of Examples 6-8 as an additive, compared with the sulphur content of gasoline produced in the absence of such compositions (“no additive”).

FIG. 3 displays the sulphur content of light cycle oil (LCO) produced during a microactivity test using the metal-containing compositions of Examples 3-8 as an additive, compared with the sulphur content of LCO produced in the absence of such compositions (“no additive”).

FIG. 4 displays the sulphur content of heavy cycle oil (HCO) produced during a microactivity test using the metal-containing compositions of Examples 3-8 as an additive, compared with the sulphur content of HCO produced in the absence of such compositions (“no additive”).

### EXAMPLES

### Example 1

Ammonium monovanadate—(NH₄)VO₃, 1.25 g—was dissolved (overnight) in 500 ml de-ionised water under continuous stirring. The pH of the clear colourless solution was adjusted to 8, using an ammonia solution (10%). 1 g of crushed Zn-MHS—Zn₅(NO₃)₂(OH)₈.2H₂O—was added under vigorous stirring. After 5 minutes the mixture was filtered and dried overnight at 65° C. The product is a fine white powder. The elemental composition (calculated as oxides) as measured with X-Ray Fluorescence Spectroscopy (XRF) was 0.79 wt % V₂O₅ and 99.2 wt % ZnO.

### Example 2

Ammonium monovanadate—(NH₄)VO₃, 1.25 g—was dissolved (overnight) in 500 ml de-ionised water under continuous stirring. The pH of the clear colourless solution was adjusted to 5, using nitric acid (20%). The suspension immediately turned orange. 1 g of crushed Zn-MHS—Zn₅(NO₃)₂(OH)₈.2H₂O—was added under vigorous stirring. After 5 minutes the mixture was filtered and dried overnight at 65° C. The product was a yellow powder. The elemental composition (calculated as oxides) as measured with XRF was 2.76 wt % V₂O₅ and 79.2 wt % ZnO.

Examples 1 and 2 show that the pH of the anion-containing solution affects the metal-containing composition that is formed. Because the composition resulting from Example 2 contains more vanadium than that of Example 1, it must be concluded that the anion incorporated into the Zn-MHS of Example 2 (at pH=5) contained more V-atoms than the anion incorporated into Example 1 (at pH=8).

### Example 3

Cu-MHS was prepared by dissolving 84.56 g Cu(NO₃)₂.2H₂O g in 100 ml H₂O, giving a 3.5 M solution. NaNO₃ was added to the solution in order to saturate the solution. The solution was then heated on a hotplate till boiling.

An amount of 250 ml 0.75 M NaOH was added drop-wise to the boiling solution under vigorous stirring, resulting in a clear green/blue suspension. The suspension was washed and the residue was dried at 60° C. in a drying oven. The dried sample (Cu-MHS) was a green powder. Powder X-ray Diffraction (PXRD) indicated the formation of Cu₂(NO₃)(OH)₃.

The so formed Cu-MHS (3.309 g) was added to a solution containing 2.534 g ammonium vanadate (NH₄VO₃). The suspension turned mustard yellow. After aging for 2 hours, this suspension was added to a slurry containing 370.4 g Catapal® (a pseudoboehmite), which had been brought to pH 7 by the addition of ammonia (10 wt. %). Next, 21.11 g cerium nitrate were added. No viscosity rise was observed.

The resulting slurry was dried at 120° C. overnight and the dried product was pulverised in a ball mill and calcined at 600° C. The colour of the resulting powder was brown.

Table 1 displays the chemical composition of the resulting product as measured by XRF.

### Example 4

A Cu-MHS prepared as in Example 3 (3.310 g) was added to a solution containing 3.232 g ammonium heptamolybdate (NH₄Mo₇O₂₄.4H₂O). The suspension remained green. After aging for 2 hours at a temperature of 60° C., this suspension was added to a slurry containing 318.2 g Catapal® (a pseudoboehmite), which had been brought to pH 7 by the addition of ammonia (10 wt. %).

The resulting slurry was dried at 120° C. overnight and the dried product was pulverised in a ball mill and calcined at 600° C. The colour of the resulting powder was dark green.

Table 1 displays the chemical composition of the resulting product as measured by XRF.

### Example 5

Mg-MHS was prepared by dissolving 76.93 g Mg(NO₃)₂.6H₂O g in 100 ml H₂O, giving a 3.0 M solution. NaNO₃ was added to the solution in order to saturate the solution. The solution was then heated on a hotplate till boiling.

An amount of 250 ml 0.75 M NaOH was added drop-wise to the boiling solution under vigorous stirring, resulting in a clear green/blue suspension. During boiling, the volume was kept constant by constant addition of liquid.

The suspension was then cooled towards 0° C. by the addition of ice water and the residue was dried at 60° C. in a drying oven. The dried sample (Mg-MHS) was a white powder. PXRD indicated the formation of Mg₂(OH)_{3.14}(NO₃)_{0.86}.0.19 H₂O and brucite (Mg(OH)₂).

The so formed Mg-MHS (2.009 g) was added to a solution containing 3.940 g ammonium vanadate (NH₄VO₃). The suspension turned slightly green. After aging for 2 hours, this suspension was added to a slurry containing 287.050 g Catapal® (a pseudoboehmite), which had been brought to pH 6 by the addition of ammonia (10 wt. %). Next, 21.93 g cerium nitrate were added. The suspension became rust coloured and no viscosity rise was observed.

The resulting slurry was dried at 120° C. overnight and the dried product was pulverised in a ball mill and calcined at 600° C. The colour of the resulting powder was brown.

Table 1 displays the chemical composition of the resulting product as measured by XRF.

### Example 6

Zn-MHS (Zn₅(NO₃)₂(OH)₈.2H₂O was ion exchanged with vanadate a follows: 30.009 g of white Zn-MHS were added to a solution containing 1.009 g ammonium vanadate (NH₄VO₃). The suspension turned slightly yellow. After aging for 2 hours, this suspension was added to a slurry containing 397.550 g Catapal® (a pseudoboehmite), which had been brought to pH 6 by the addition of ammonia (10 wt. %).

The resulting slurry was dried at 120° C. overnight and the dried product was pulverised in a ball mill and calcined at 600° C. The colour of the resulting powder was mustard yellow.

Table 1 displays the chemical composition of the resulting product as measured by XRF.

### Example 7

Zn-MHS was ion-exchanged with tungstate, as follows:

30.000 g of white Zn-MHS were added to a solution containing 0.546 g ammonium tungstate ((NH₄)₆(W₁₂O₄₁)). The suspension remained white. After aging for 2 hours, this suspension was added to a slurry containing 397.700 g Catapal® (a pseudoboehmite), which had been brought to pH 6 by the addition of ammonia (10 wt. %).

The resulting slurry was dried at 120° C. overnight and the dried product was pulverised in a ball mill and calcined at 600° C. The colour of the resulting powder was white.

Table 1 displays the chemical composition of the resulting product as measured by XRF.

### Example 8

Zn-MHS was ion-exchanged with molybdate, as follows:

30.000 g of white Zn-MHS were added to a solution containing 0.462 g ammonium molybdate (NH₄Mo₇O₂₄.4H₂O). The suspension remained white. After aging for 2 hours, this suspension was added to a slurry containing 397.600 g Catapal® (a pseudoboehmite), which had been brought to pH 6 by the addition of ammonia (10 wt. %).

The resulting slurry was dried at 120° C. overnight and the dried product was pulverised in a ball mill and calcined at 600° C. The colour of the resulting powder was white.

Table 1 displays the chemical composition of the resulting product as measured by XRF.

TABLE 1
Elemental compositions of the products of Examples 3-8.
elemental composition in % (calculated as oxides)*

| Example: | Al | Ce | V | Mo | W | Cu | Zn | Mg | Na |
|---|---|---|---|---|---|---|---|---|---|
| 3 (Cu—V) | 70.90 | 13.10 | 6.80 | — | — | 8.60 | — | — | — |
| 4 (Cu—Mo) | 74.60 | — | — | 13.40 | — | 10.00 | — | — | — |
| 5 (Mg—V) | 61.40 | 14.90 | 19.20 | — | — | — | — | 3.60 | — |
| 6 (Zn—V) | 44.60 | — | 1.90 | — | — | — | 53.00 | — | — |
| 7 (Zn—W) | 44.30 | — | — | — | 1.30 | — | 53.10 | — | 0.40 |
| 8 (Zn—Mo) | 52.00 | — | — | 0.90 | — | — | 46.00 | — | 0.50 |

*The percentages do not add up to 100% due to traces of other elements.

### Example 9

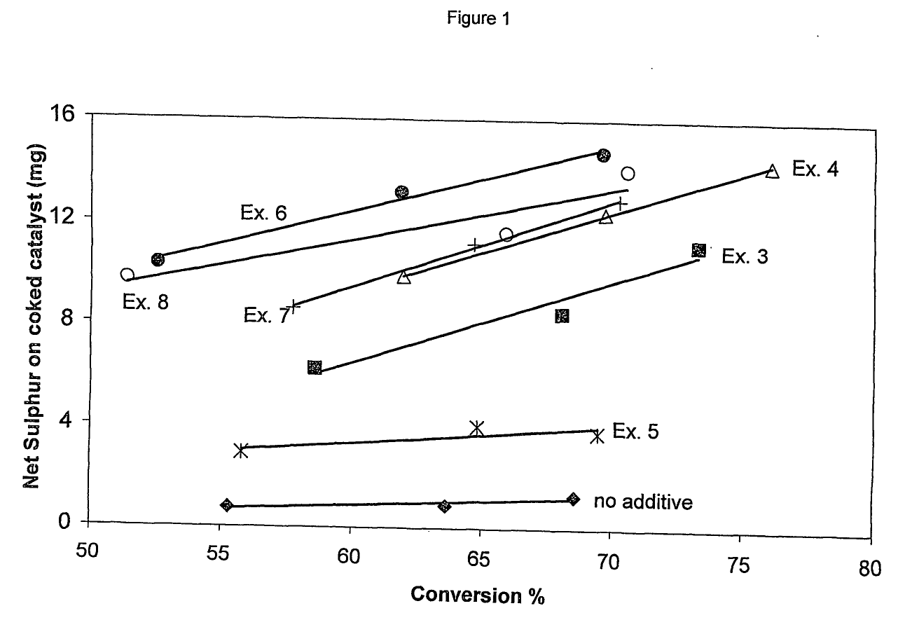

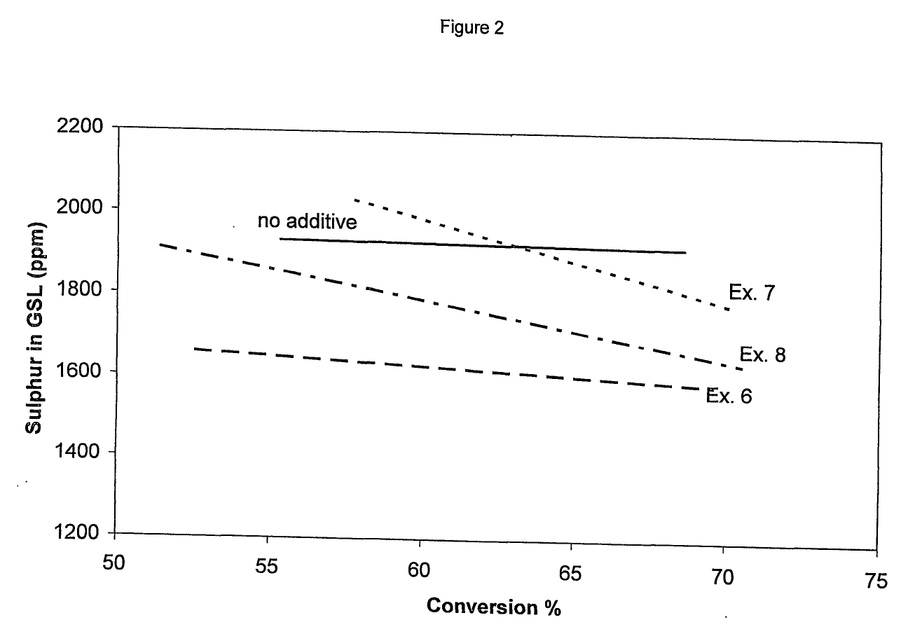

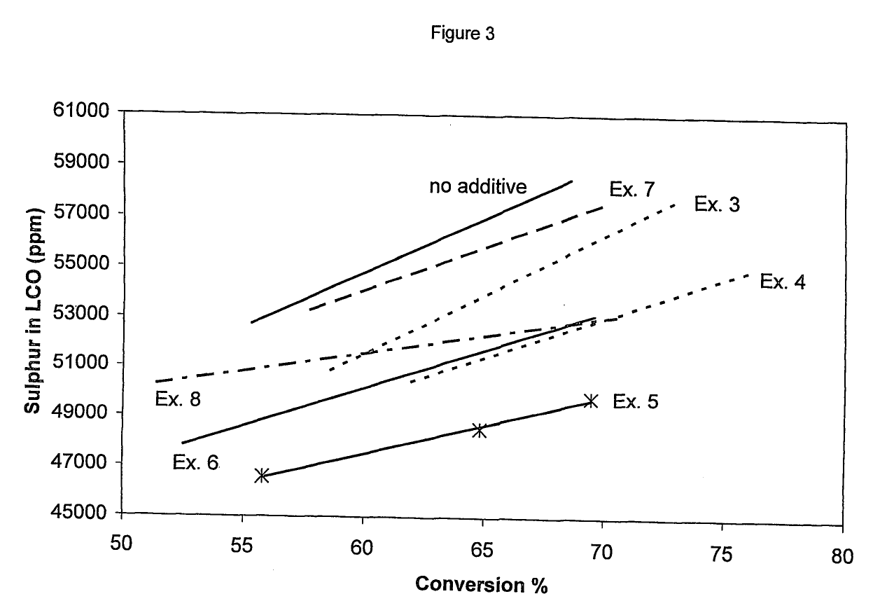

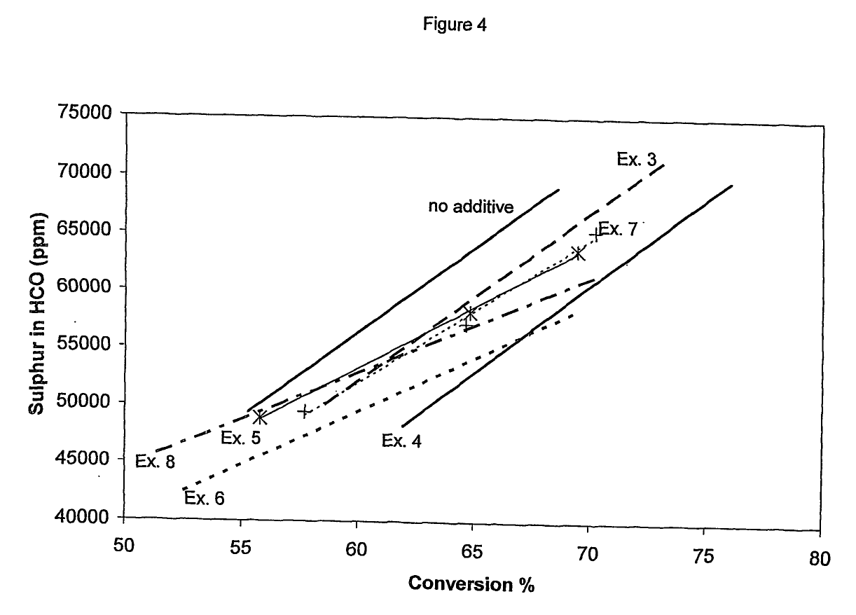

Mixtures were prepared containing 20 wt % of the products of Examples 3-8 (as additive) and. 80 wt % of an equilibrium FCC catalyst (E-cat). These mixtures were tested in Micro Activity Test (MAT) Unit. The sulphur taken up by the additive and the sulphur concentration in the resulting gasoline, light cycle oil (LCO), and heavy cycle oil (HCO) are shown in FIGS. 1-4 and compared with 100 wt % E-cat (‘no additive’).

From these figures it can be concluded that metal-containing compositions according to the invention can be used for the preparation of additives that are very suitable in FCC for the production of fuels with a reduced sulphur content: these additives reduce the sulphur concentration in LCO and HCO. The sulphur content of the coke deposited on these additives is higher than the sulphur content of E-cat without additive. Especially the compositions formed from Zn-MHS are successful in reducing the sulphur content of gasoline.

In addition, it has been observed that the cracking activity of the composition of Example 7 (Zn-MHS exchanged with tungstate) was slightly higher than that of the E-cat used. This means that relatively large amounts of this composition can be added to the unit without sacrificing conversion. At high conversions, this composition produced even more gasoline than E-cat, with comparable coke formation.

1. Metal-containing composition obtainable by contacting a metal hydroxy salt with a solution comprising one or more pH-dependent anions selected from the group consisting of pH-dependent boron-containing anions, vanadium-containing anions, tungsten-containing anions, molybdenum-containing anions, iron-containing anions, niobium-containing anions, tantalum-containing anions, aluminium-containing anions, and gallium-containing anions.

2. Metal-containing composition according to claim 1 wherein the metal hydoxy salt is built up from one or more divalent metals selected from the group consisting of Ni²⁺, Co²⁺, Cu²⁺, Cd²⁺, Ca²⁺, Zn²⁺, Mg²⁺, Fe²⁺, and Mn²⁺.

3. Metal-containing composition according to any one of the preceding claims in the form of shaped bodies.

4. Metal-containing composition according to claim 3 in the form of particles with a diameter of less than 500 nm.

5. Catalyst composition comprising a metal-containing composition according to any one of the preceding claims and at least one compound selected from the group consisting of metal (hydr)oxides, clays, aluminium phosphates, zeolites, phosphates, pore regulating agents, binders, fillers, and combinations thereof.

6. Composition comprising a metal-containing composition according to any one of claims 1-4 and an organic polymer.

7. Process for the preparation of a metal-containing composition according to claim 1 wherein a metal hydroxy salt is contacted with a solution comprising one or more pH-dependent anions selected from the group consisting of pH-dependent boron-containing anions, vanadium-containing anions, tungsten-containing anions, molybdenum-containing anions, iron-containing anions, niobium-containing anions, tantalum-containing anions, aluminium-containing anions, and gallium-containing anions.

8. Process for the preparation of a catalyst composition according to claim 5 wherein a metal-containing composition according to any one of claims 1-4 is added to a slurry having a pH in the range 2-10 and comprising at least one compound selected from the group consisting of metal (hydr)oxides, clays, aluminium phosphates, zeolites, phosphates, pore regulating agents, binders, fillers, and combinations thereof, and (ii) spray-drying the slurry

9. Process according to claim 7 or 8 followed by calcination.

10. Process according to any one of claims 7-9 followed by reduction.

11. Process according to any one of claims 7-10 followed by sulphidation.

12. Use of the metal-containing composition according to any one of claims 1-4 for the preparation of a catalyst or catalyst additive composition suitable for use in fluid catalytic cracking, hydrodesulphurisation, hydrodenitrogenation, demetallisation, hydrocracking, Fischer-Tropsch, hydrogenation, dehydrogenation, or isomerisation process.

13. Use of the metal-containing composition according to any one of claims 1-4 for the preparation of a catalytst or catalyst additive composition suitable for the reduction of SOₓ and/or NOₓ in FCC regenerators.

14. Use of the metal-containing composition according to any one of claims 1-4 for the preparation of a catalytic composition for the reduction of the sulphur and/or nitrogen content of fuels.
